(19) United States
(12) Patent Application Publication
(10) Pub. No.: US 2006/0065590 A1
(43) Pub. Date: Mar. 30, 2006

(54) FILTER SYSTEM FOR CONTAINERS AND CONTAINER OPENINGS

(76) Inventor: Paul Alan Scharf, New York, NY (US)

Correspondence Address: WILLIAM COLLARD;COLLARD & ROE, P.C., 1077 NORTHERN BOULEVARD, ROSLYN, NY, 11576, US

(21) Appl. No.: 11/162,940

(22) Filed: Sep. 28, 2005

Related U.S. Application Data
(60) Provisional application No. 60/614,404, filed on Sep. 28, 2004.
(60) Provisional application No. 60/614,373, filed on Sep. 29, 2004.

(51) Int. Cl. B01D 35/02

(52) U.S. Cl. 210/460; 210/499; 210/767; 285/18; 141/1

(57) ABSTRACT

A filter system for a container comprising a connector, an adjustable tube coupled to the connector and a filter coupled to said adjustable tube. The adjustable tube can be in the form of a corrugated tube or in the form of a telescoping tube. This system can be coupled to either the input or the output of a container.

### CROSS REFERENCE TO RELATED APPLICATIONS

This application is a non-provisional application and hereby claims priority from U.S. Provisional Application Ser. No. 60/614,404 filed on Sep. 28, 2004, and U.S. Provisional Application Ser. No. 60/614,373 filed on Sep. 29, 2004.

### BACKGROUND OF THE INVENTION

1. Field of the Invention

This invention relates to a filter system for an opening of a container. In particular, the invention relates to a filter bag that can be removably connected to the opening of a container or a container dispensing device to prevent ambient dust and dirt from contaminating the container contents as they are dispensed, and to prevent any particulate matter inside the dispensing container from exiting the container and contaminating other products. The invention can also be attached to the opening of a container to filter any liquid entering the container. This device can also be used as a filter.

2. The Prior Art

When transferring chemicals or other liquid material to a container from another container, dust and other particulate matter in the warehouse, where the container is stored, can contaminate the liquid material as it flows into the container. In addition, the dispensing container can also contain contaminants that can contaminate products if not filtered when dispensed.

There have been attempts in the past to create a filter mechanism for the container by taping a filter material to the opening. However, this arrangement is not durable and the filter often falls off during transfer.

### SUMMARY OF THE INVENTION

It is therefore an object of the invention to provide a filter system for an opening of a container that is reliable and easy to use.

It is another object of the invention to provide a filter system for an opening of a container that is simple and inexpensive to manufacture.

These and other objects are accomplished by a filter system for a container opening comprising a filter bag that consists of a flexible bag made of a liquid-permeable material, and an attachment device for securely but removably connecting the filter bag to the opening. Preferably, the filter bag is made of a nylon or other synthetic mesh, which is both durable and flexible. The bag can be connected to a connector which can be in any form such as an octagon ring, a hex ring or other ring-like device that fits within the opening such as a dispensing or receiving end of a container, via an attachment device.

The attachment device may comprise a screw attachment. This is accomplished by external threads disposed around a ring-like attachment at the top open end of the filter bag. The ring-like device on the container opening or valve/faucet is then given corresponding internal threads, onto which the filter bag is screwed.

Alternatively, the container could have external threads and the filter could have internal threads. The ring-like attachment on the filter bag is preferably a hollow cylindrical piece of plastic that can be in the form of an accordion tube that is permanently attached to the top open end of the filter bag. In another embodiment, the filter is attached to the container via clips or catches. These clips can be either on the container or on the filter bag, and most preferably on a ring-like attachment around the top of the filter bag. The clips are preferably snapped into corresponding indentations, or forced over corresponding protrusions on the container opening, to secure the filter to the container.

For large capacity containers, merely attaching a filter bag on the container opening may create too much pressure of the contents flowing through the container, and prevent proper transfer. Accordingly, an extension device is provided, which attaches to both the container and to the filter bag, and allows the filter bag to be attached at a predetermined distance from the container opening. Thus, the liquid material flows through the extender before reaching the filter, and some of the volume and velocity of the liquid flow is then reduced by this traveling.

The extender can also be attached to the ring opening and to the filter bag via a screw-like attachment or via catches. Any suitable attachment means can be used.

The extender preferably has an accordion-like structure, so that it can bend and flex as it is inserted into the container. The accordion like structure also allows the length of the extender to be adjusted according to the size of the container. Other structures could be used as well. The accordion like tube can be in the form of an accordion type structure which is for saving space and also prevents kinking and can provide an exact length for a connection. This accordion like device can also be compressed so that when it is compressed, it allows for the removal of additional material that would otherwise be stored inside of the tube. The compression collapses the tube squeezing the tube to a smaller structure with side sections compressing against each other thereby forcing fluid outside of the tube.

In addition, because of these adjustable tubes, wherein these tubes are adjustable in length and also easily bendable, a user can move fluid or liquid easily from one large container to another without having to move these heavy containers. Therefore, this design allows for an easy transfer of this fluid.

The filters can be replaced when they are worn out. In addition, filters of different mesh sizes can be supplied, to enable filtration of fluids having different viscosities.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1A is an exploded side perspective view of a first embodiment of the device;

FIG. 1B shows an exploded perspective view of another embodiment of the invention wherein there is shown a plurality of filter elements including a sealing ring;

FIG. 1C is an exploded side perspective view of the device as shown in FIG. 1A with the adjustable tube shown in its bent form;

FIG. 2A is a side cross-sectional view of the device shown in FIG. 1A which further includes a connector;

FIG. 2B is a side cross-sectional view of the device shown in FIG. 2A coupled to a container;

FIG. 2C is a side cross-sectional view of the device shown in FIG. 2B with the adjustable tube shown in a bent form;

FIG. 3A shows a side cross-sectional view of the adjustable tube coupled to a connector and to a filter and a valve/faucet;

FIG. 3B shows a side view of a valve/faucet coupled to an adjustable tube which is coupled to a filter and being positioned over a container;

FIG. 3C shows a side view of a valve/faucet coupled to an adjustable tube which is coupled to an opening in a container, wherein this opening has a connector which is coupled to an additional adjustable tube coupled to a filter;

FIG. 4A shows a side exploded view of the device including a circular connection adapter which can be coupled to a flexible tube and a filter;

FIG. 4B shows the side view of the embodiment shown in FIG. 4A coupled together and coupled to a container;

FIG. 5 shows a side view of another embodiment of the invention;

FIG. 6A shows a side view with a valve/faucet, a tube and a filter coupled together with the coupling being shown in a cross-sectional manner;

FIG. 6B shows a side view of the device shown in FIG. 6A with the tube shown in a bent position;

FIG. 7 shows a side view of a dual filter device which shows the device shown in FIG. 6A and also the device shown in FIG. 2B wherein this view shows the method or system for filtering fluid;

FIG. 8A shows a side view with a second style valve, a tube and a filter;

FIG. 8B shows a side view of the device shown in FIG. 8A with these elements coupled together;

FIG. 8C shows a side view of the device shown in FIG. 8B with the tube in a bent position and coupled to a dispensing container;

FIG. 9 shows a side view of a device similar to that shown in FIG. 8C with an elongated tube;

FIG. 10A shows a perspective view of a coupling adapter in an extended position with a safety seal;

FIG. 10B shows a side perspective view of another coupling adapter in an extended position without the safety seal;

FIG. 10C shows a top perspective view of the device shown in FIG. 10A in a fully retracted position;

FIG. 10D shows a top perspective view of the device shown in FIG. 10B in a fully retracted position;

FIG. 10E shows a side perspective view of the device shown in FIG. 10A and in FIG. 10B with a closure cap;

FIG. 10F shows a side view of the device shown in FIG. 10A and in FIG. 10B with a closure cap attached;

FIG. 10G shows an exploded side perspective view of the device shown in FIG. 10B and an adjustable tube and a filter;

FIG. 10H shows these elements shown in FIG. 10G all coupled together;

FIG. 10I shows a side view of the device shown in FIG. 10H with the adjustable tube in a bent position;

FIG. 10J shows a side exploded view of the device shown in FIG. 10G with the coupling element being coupled to a container;

FIG. 10K shows a side view of the device shown in FIG. 10J with the tube in a bent position;

FIG. 10L shows a dual filter device which includes the filter shown in FIG. 10K which is positioned adjacent to the device shown in FIG. 2A;

FIG. 10M shows a side view of a closure cap which can be placed on a container after an accordion filter has been removed;

FIG. 11A shows an exploded side perspective view of a funnel, adjustable tube and filter;

FIG. 11B shows a side perspective view of the device coupled together;

FIG. 11C shows a side view of the device shown in FIG. 11B inserted into a receiving opening in a container;

FIG. 12A shows a side exploded view of a dispenser coupled to a container with an adjustable tube and filter shown in an exploded view adjacent to the dispenser;

FIG. 12B shows a side view of the device shown in FIG. 12B with the elements coupled together;

FIG. 12C shows a side view of a device similar to that shown in FIG. 12B with a longer adjustable tube being used;

FIG. 13 shows a side view of multiple embodiments of these devices used in a multi-layered platform; and

FIG. 14 is a flow chart for the process for filtering fluid from one container to another.

### DETAILED DESCRIPTION OF THE PREFERRED EMBODIMENTS

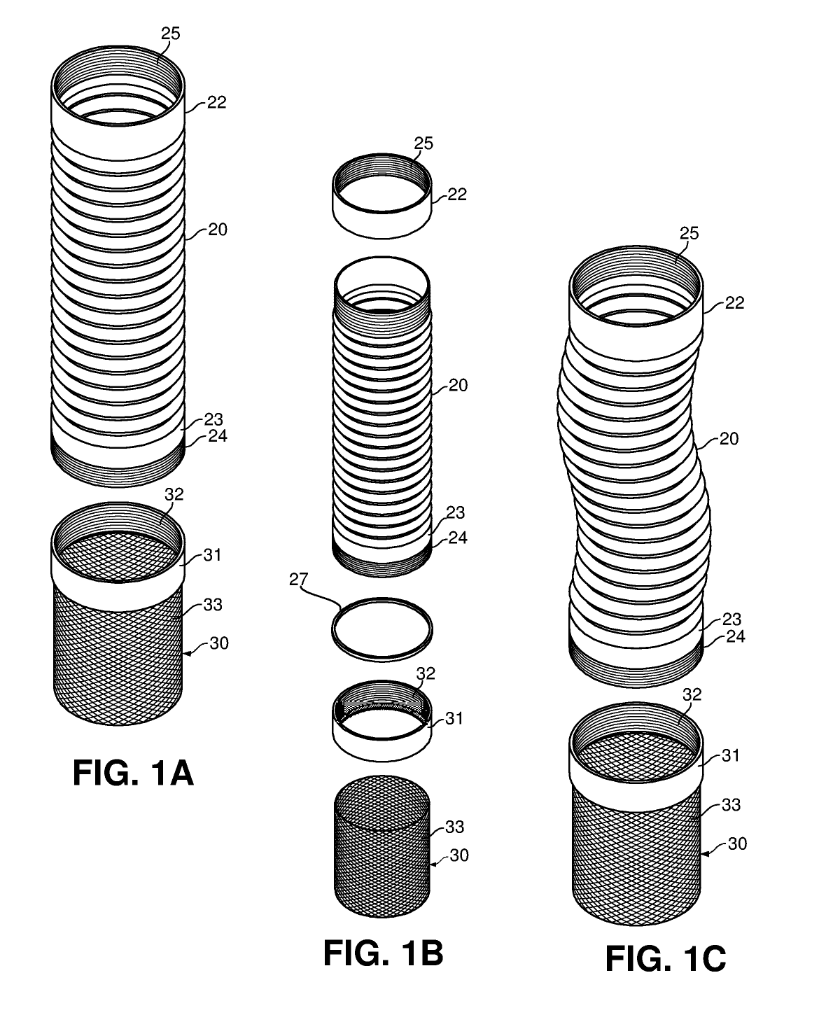

Referring in detail to the drawings FIG. 1A shows a side perspective view of an adjustable tube 20 which can include a first or top end ring 22 and a bottom end ring 23 with the top end ring having a set of inner threads 25 coupled to an outside face of the top ring 22. There is also a set of outer threads 24 which are coupled to the second or bottom ring 23.

This adjustable tube 20 can be coupled to a filter 30, wherein filter 30 can include a coupling ring 31 which has a set of inner threads 32. A mesh screen 33 is coupled to ring 31 as well.

FIG. 1B shows a side exploded view of the device wherein in this view, there is shown a sealing ring 27 which can be coupled to coupling ring 31 to form a fluid sealed connection when inner threads 32 are screwed onto outer threads 24. In this view, mesh screen 33 is shown detached as well.

FIG. 1C shows the side view of the device as shown in FIG. 1A, wherein adjustable tube is shown as a flexible or adjustable tube 20.

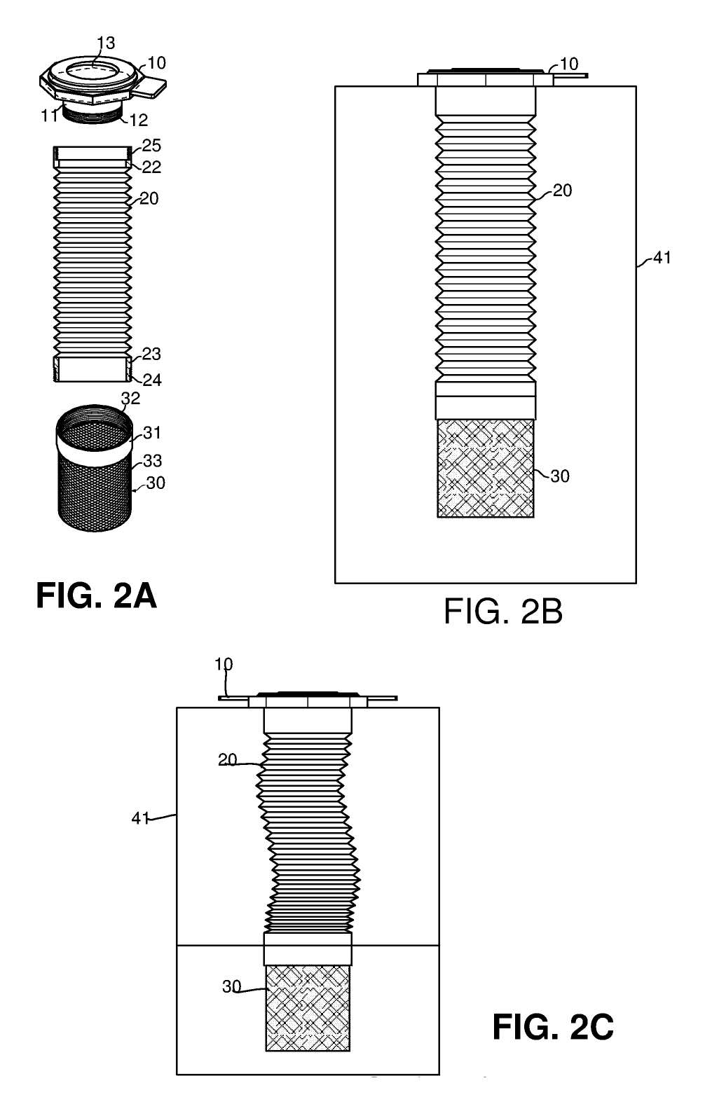

FIG. 2A shows a side view of the device shown in FIG. 1B with an additional connector which can be in the form of a connector such as an octagon ring 10 which can be coupled to adjustable tube 20. Octagon ring 10 can include an insert shaft 11 which also has a threaded section 12. There is an inner region or hole 13 which can be used to receive an inflow of material or fluid. This octagon ring can be coupled to a container 41 as shown in FIG. 2B. Octagon ring 10 forms an adapter for coupling to container 41 so that adjustable tube 20 can extend inside of container 40 while allowing fluid to flow inside of adjustable tube 20 and then be filtered by filter 30 before flowing into the remaining section of container 41.

FIG. 2C shows a side cross-sectional view of the device shown in FIG. 2B with adjustable tube 20 shown in a bent or curved position.

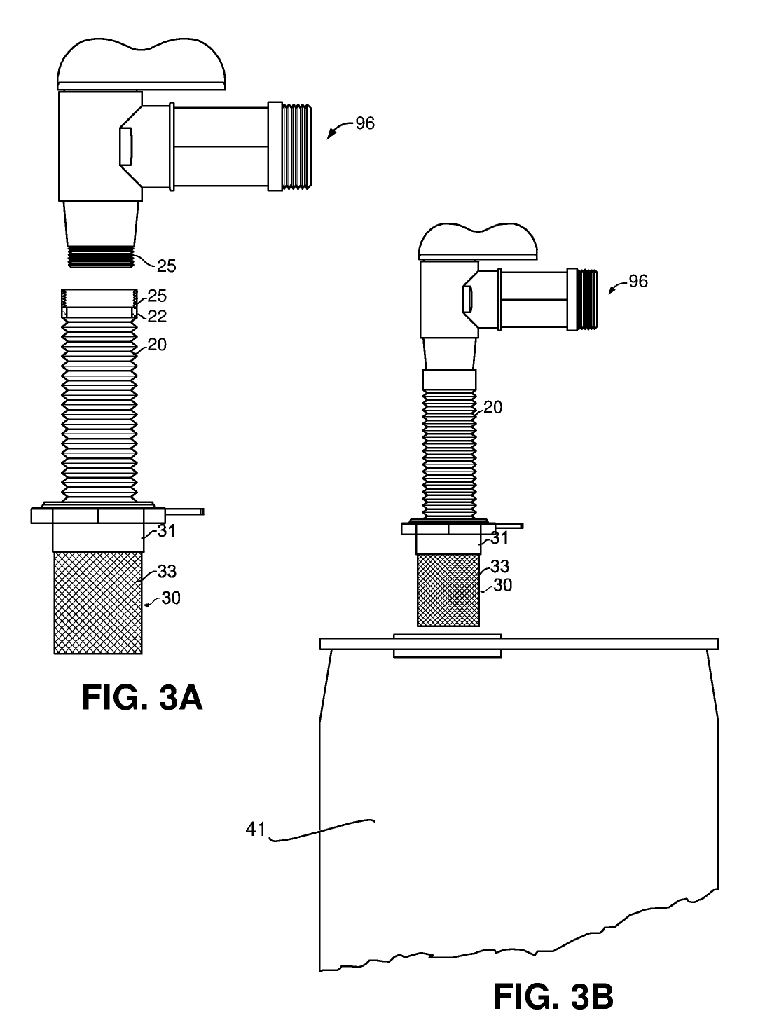

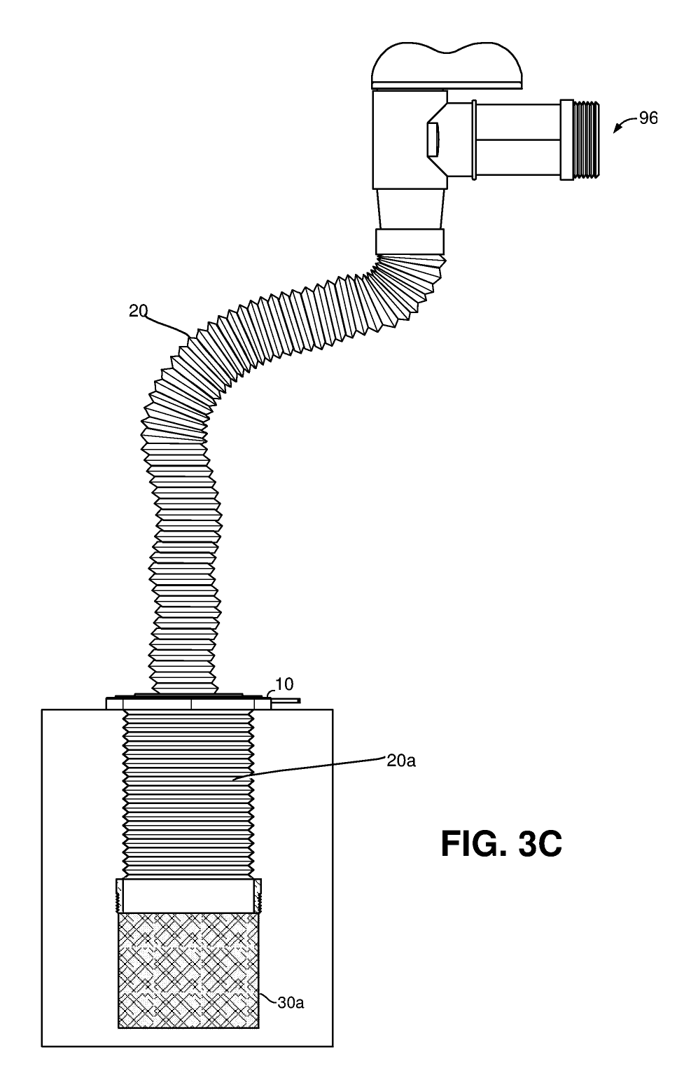

FIG. 3A shows a side cross-sectional view of the adjustable tube 20 coupled to a connector 10 and to a filter 30 at a first end, and to a valve/faucet 96 at a second end.

FIG. 3B shows a side view of a valve/faucet 96 coupled to an adjustable tube 20 which is coupled to a filter and being positioned over a container 41;

FIG. 3C shows a side view of a valve/faucet 96 coupled to an adjustable tube 20 which is coupled to an opening in a container 41. This opening has a connector 10 which is coupled to an additional adjustable tube 20a which is also coupled to a filter 30a. In this case, the adjustable tube 20a and filter 30a similar to tube 20 and filter 30 but are second in the order of flow of fluid and are housed inside of container 41 so that the filtering occurs inside of container 41.

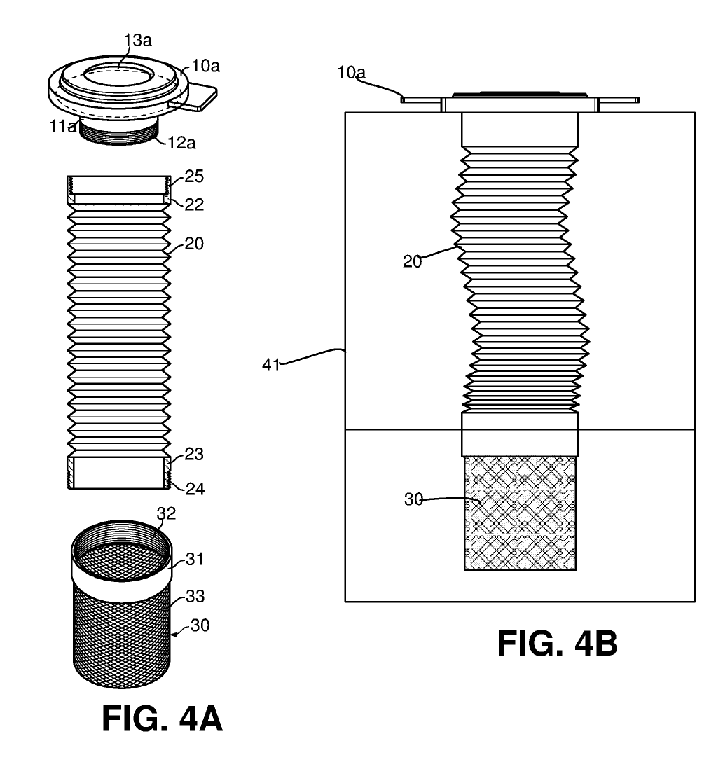

FIG. 4A shows a side perspective view of a connecting ring 10a which can be used to couple an adjustable tube 20 to a container. This connecting ring 10a has a shaft section 11 a, a threaded section 12a and an opening section 13a to receive fluid to flow therein. Threaded section 12a can be used to couple connecting ring 10a to adjustable tube 20. In addition, with this view a filter 30 can be coupled to an opposite end of the adjustable tube.

FIG. 4B shows a side view of the device shown in FIG. 4A wherein this device is coupled together and then also coupled to a container 41 as well, wherein adjustable tube 20 can then be coupled to connecting ring 10a with threads 25 screwing onto threads 12a (See FIG. 4A) to couple adjustable tube 20 to connecting ring 10a. In addition, with this view, filter 30 can then be coupled to adjustable tube 20 with threaded region 32 of filter 30 being screwed onto threaded region 24.

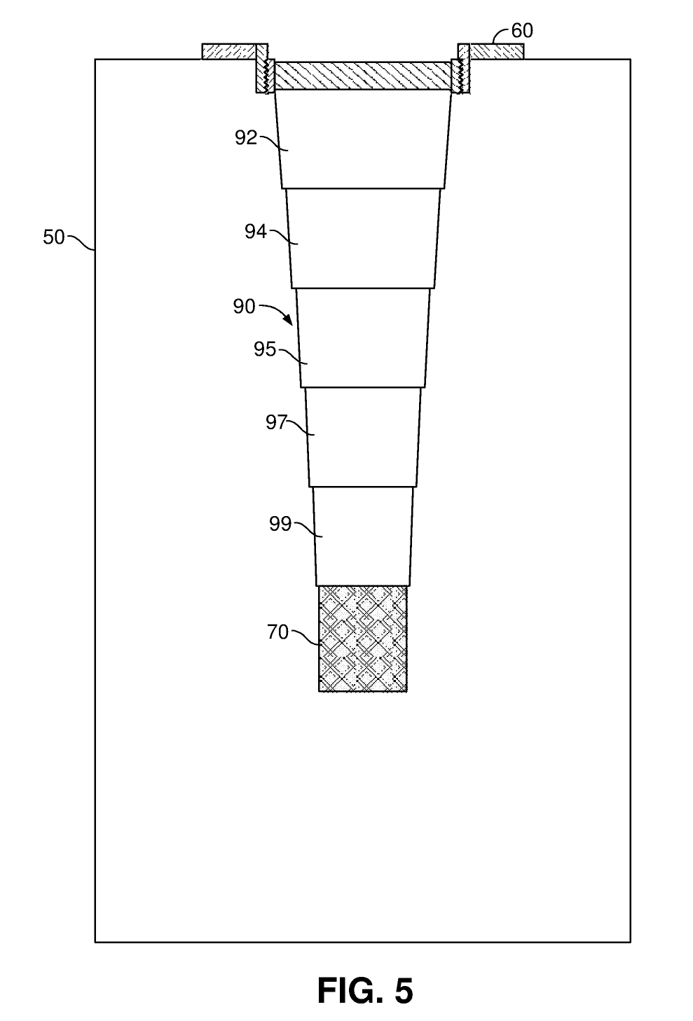

FIG. 5 shows a side view of another embodiment of the invention. In this embodiment, there is shown a telescoping tube which can be coupled to a container 50 via an adapter 60. This telescoping tube can include a series of different stages or cup regions 92, 94, 95, 97, and 99. Coupled to end 99 there is a filter element 70 which can couple to an inside region of telescoping end element 99. This filter element 70 can be similar to filter element 30.

This type of telescoping tube is collapsible and therefore adjustable in length.

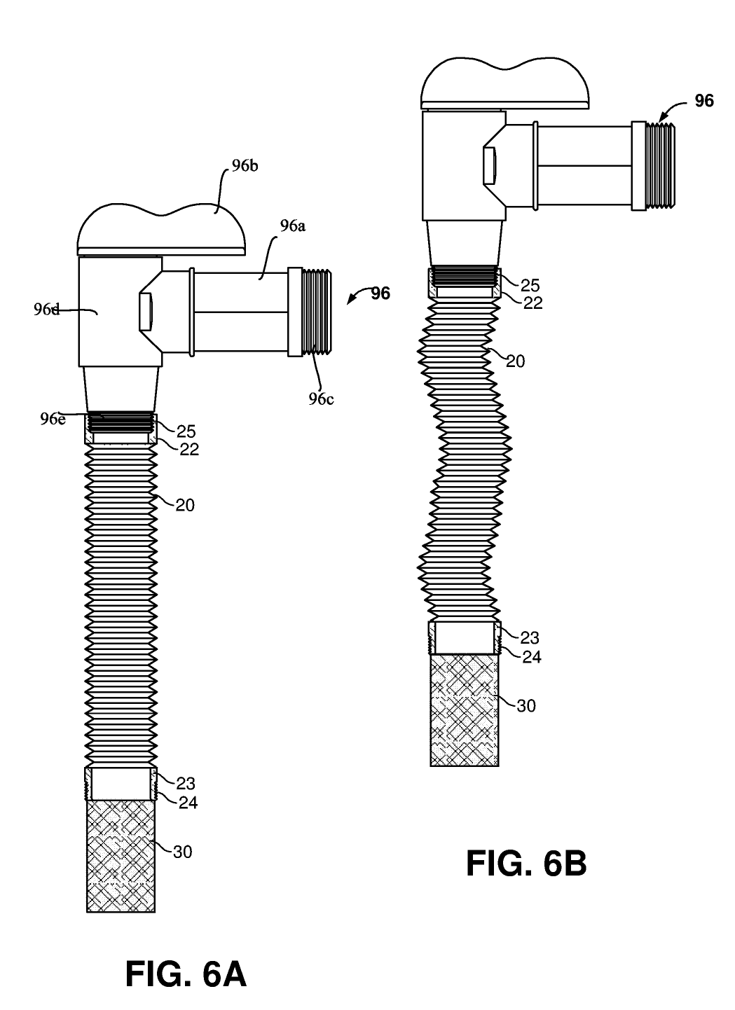

FIG. 6A shows a side view of another embodiment of the invention wherein this device could include a valve 96 which includes a body section having at least a first section 96a, a second section 96d and two threaded sections 96c and 96e. Three is also a valve handle, flange or turn element 96b which allows valve 96 to be selectively opened or closed when handle 96b is turned.

FIG. 6B shows a side view of this embodiment wherein there is shown tube 20 which is in a curved or bent position with valve 96 at one end and filter 30 disposed at an opposite end.

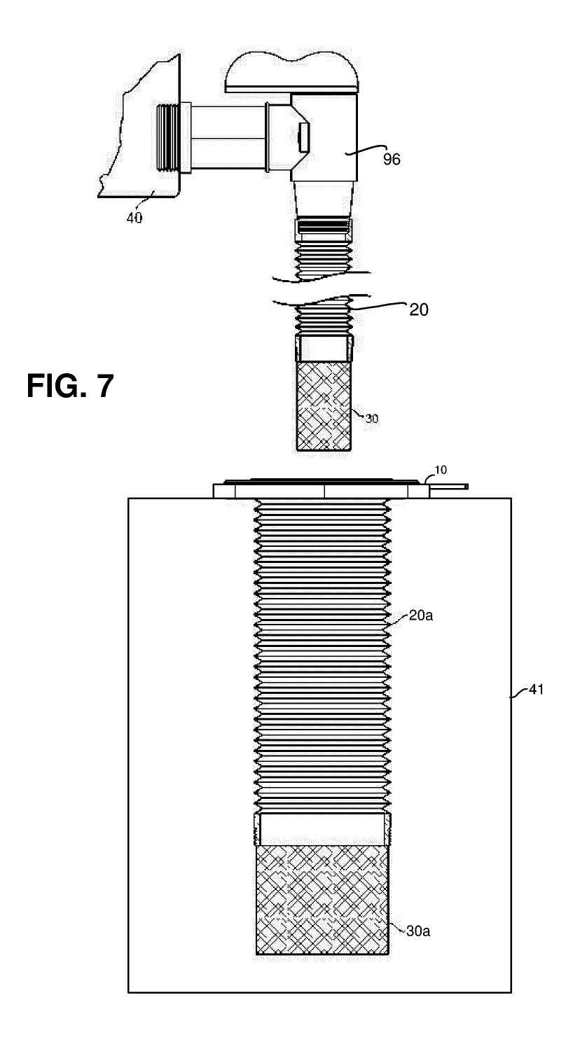

FIG. 7 shows a side view of another embodiment of the invention wherein with this design, there is the embodiment shown in FIG. 6B coupled to an adjacent container 40 for allowing the filtering of fluid which flows from the container 40 and which can then flow into an adjacent or lower container 41.

This view is also shown the embodiment shown in FIG. 2B which shows a ring 10, coupled to a container 41, and an adjustable tube 20a and a filter 30. With this design, valve 96 can be screwed onto an associated container 40, while adjustable tube 20 can be coupled to valve 96. Coupled to adjustable tube 20 is filter 30.

In addition, ring 10 is coupled to container 41 by octagon ring onto container 41. Octagon ring 10 is also coupled to adjustable tube 20. Adjustable tube 20 is also coupled to another filter 30 at an opposite end. With this design, fluid can flow outside of container 40, into valve 96, down through adjustable tube 20, through filter 30 wherein at this point, the fluid flows into the ambient air and then down through a hole section in opening or octagon ring 10, down into additional tube 20a and then down through filter 30a. The fluid is filtered first before leaving first container 40, and then filtered again before the fluid flows into the second container 41. This design is beneficial because the second step of filtering keeps any additional impurities obtained from the ambient air, from entering into the final container 41.

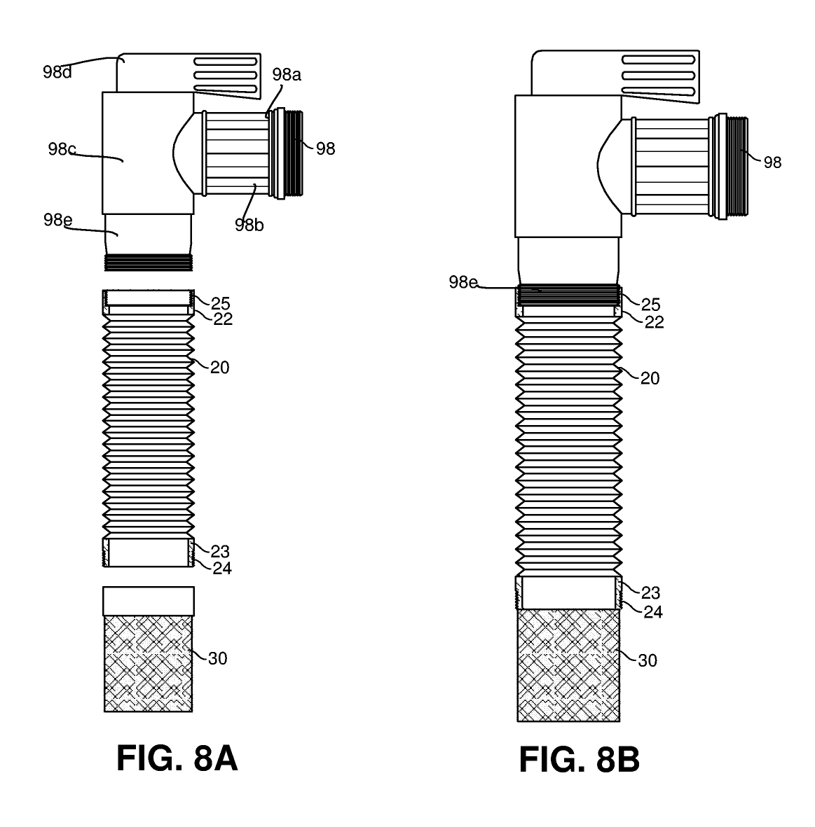

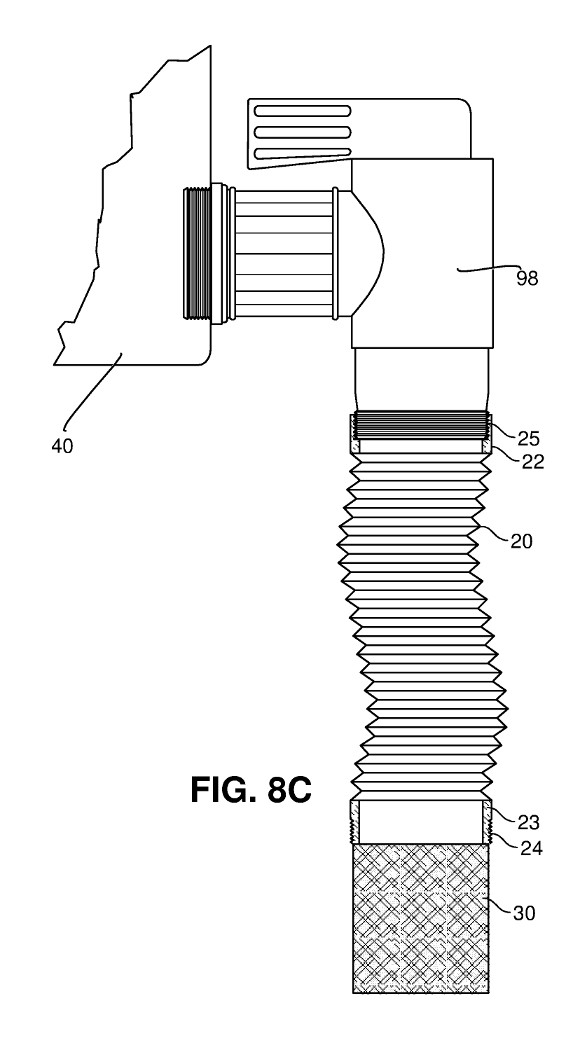

Different valves can also be used. For example FIGS. 8A, 8B, and 8C show that a second style valve 98 can be used as well. With this design second style valve 98 has a different turn handle 98f. This type of valve 98 includes a first threaded section 98d, and a second threaded section 98e. There are also two body sections 98b, and 98c with a different style turn handle 98d. FIG. 8B shows these parts coupled together with treaded region 25 being coupled to threaded region 98E. FIG. 8C shows this tube 20 in a bent position.

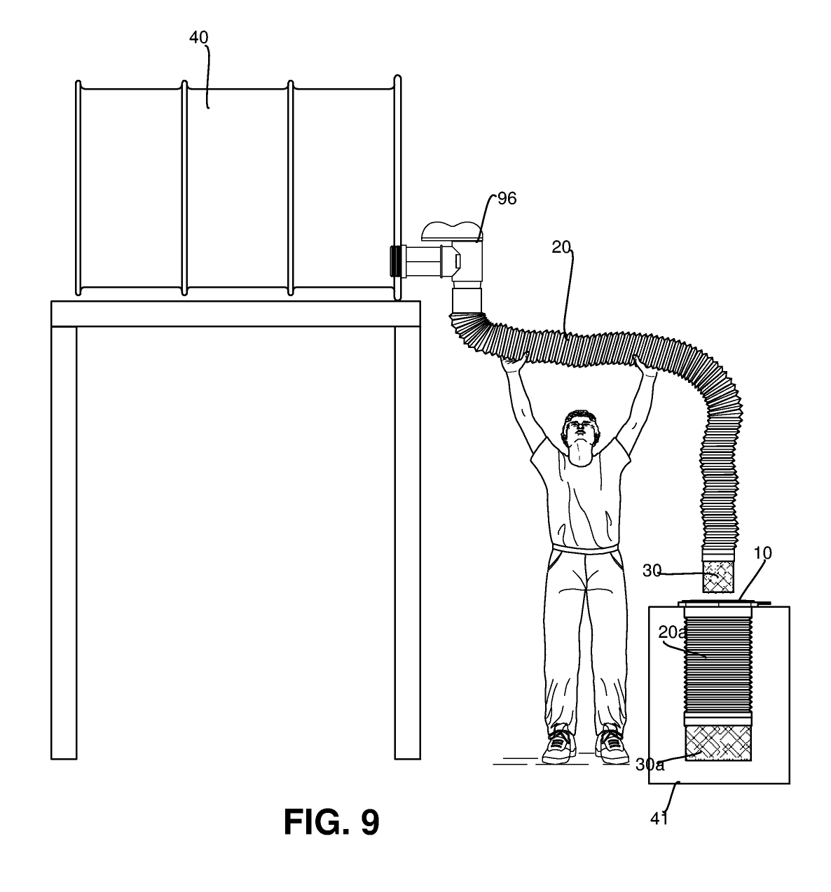

FIG. 9 shows a side view of another embodiment of the invention, wherein this view shows a first container 40, a valve 96, and an adjustable tube 20 which is coupled to valve 96. Coupled to adjustable tube 20 is a first filter 30. Below first filter 30 is a container 41 which houses a octagon ring 10 which is coupled to a top section of container 41. Coupled to ring 10 is adjustable tube 20a and additional filter 30a. With this design, there is a double filtering effect as described above in relation to FIG. 7C.

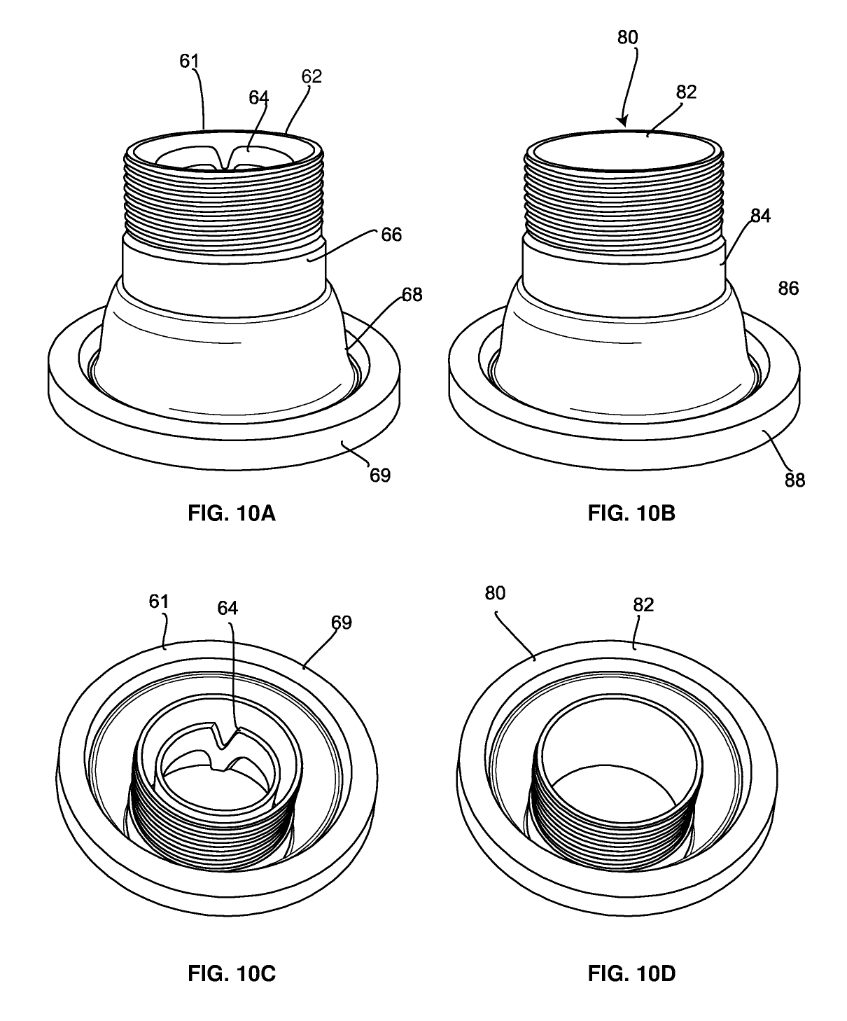

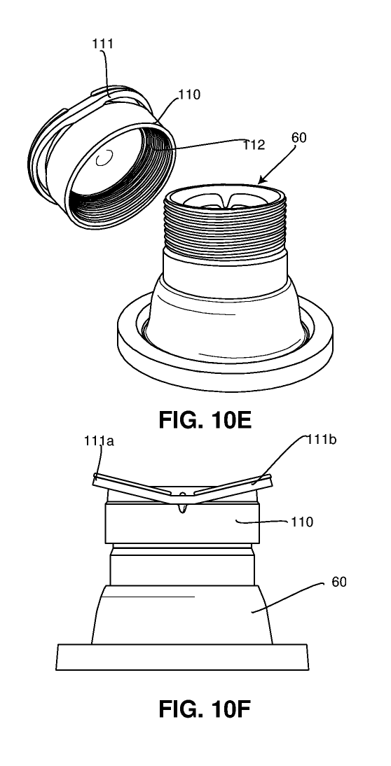

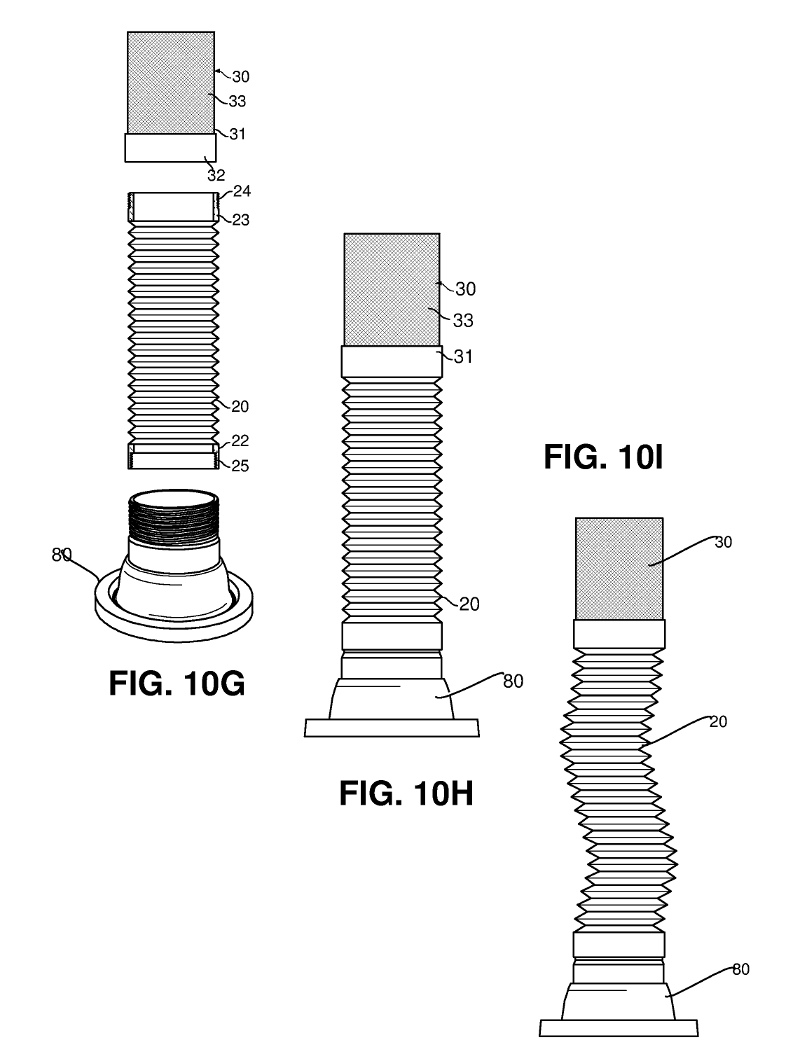

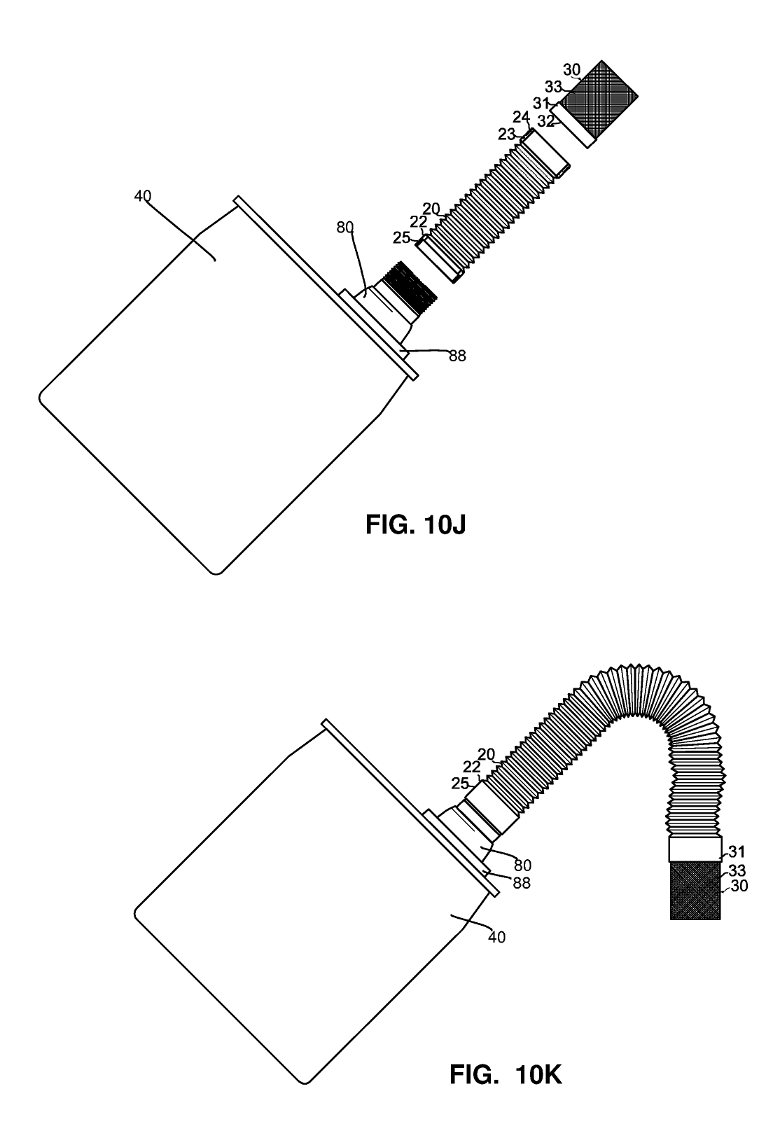

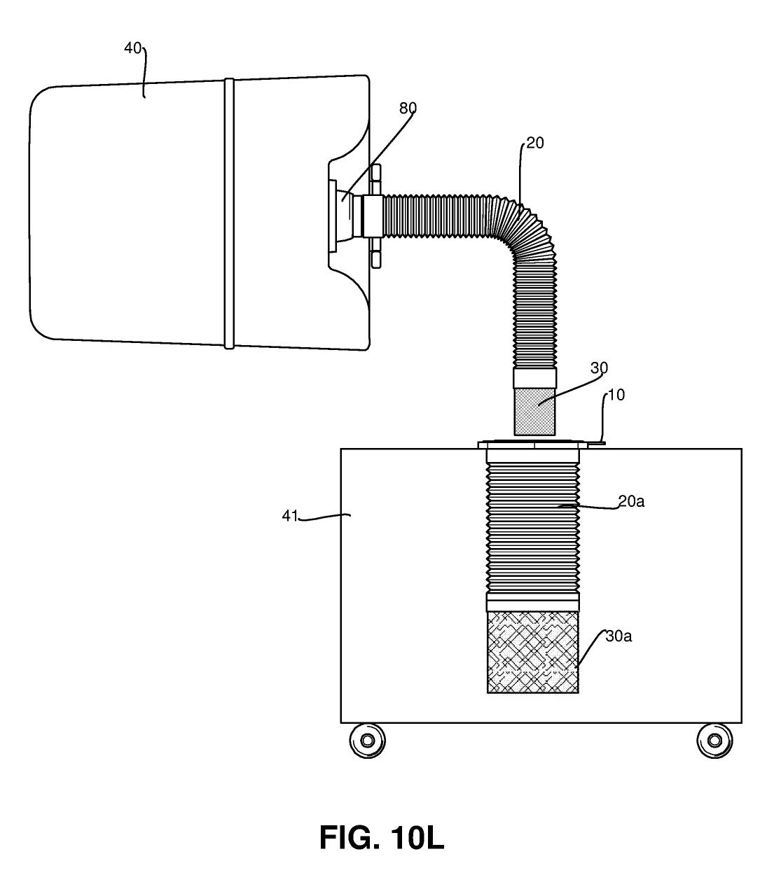

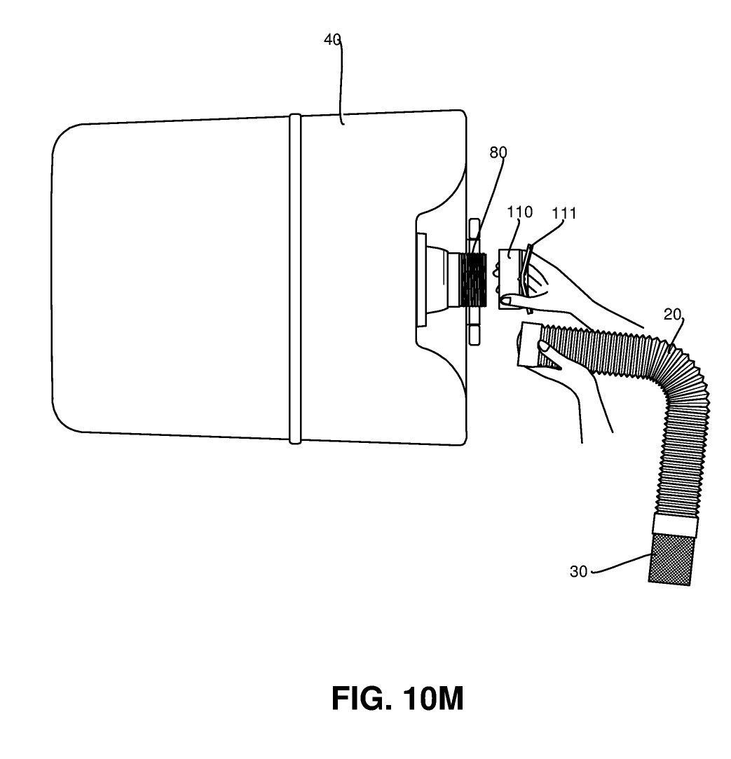

FIGS. 10A, and 10C, disclose two different embodiments of a collapsible dispensing element or plug 61, which includes a top threaded section 62, an inner safety seal 64 an intermediate section 66, a flexible collapsing section 68 and a base ring 69. In addition, FIGS. 10B and 10D disclose a second embodiment of a collapsible connector 80. This collapsible connector 80 includes a top section 82 which includes threads, an intermediate section 84, a flexible or collapsible section 86 and a base ring section 88. FIG. 10D shows this device in a collapsed position.

FIG. 10E shows a side view of collapsible connector 60 which can be connected to a closure cap element 110. Quick connect element 110 includes an inner threaded section 112 and wings 111, including two flexible wings 111a and 111b as shown in FIG. 10F. When the wings 111 are pressed or crimped in, it creates a receiving connection position for receiving a tube.

FIGS. 10F, 10G, and 10H, show the combination of a collapsible connector 80, which includes threaded section 82 (See FIG. 10G) which can be coupled to an inside threaded section 25 of adjustable tube 20.

FIGS. 10J and 10k show the coupling of the device shown in 10F, 10G, 10H and 10I coupled to a container 40. FIG. 10L shows how in this embodiment, fluid can flow through two different filters, first out of container 40, through connector 80, through tube 20, through filter 30, through ring 10, through tube 20a and then through filter 30a and into container 41.

FIG. 10M shows a side view of another embodiment of the invention. In this embodiment, a quick connect device 110 can be used to connect to connector element 80 which is connected to container 40. In addition, there is adjustable tube 20a which can connect to quick connect 110 wherein this device also includes a filter 30 as well. With this design, the quick connect can connect to the tube 20 and then be screwed onto connector 80 so that this design allows for the easy release of tube 20 from container 40.

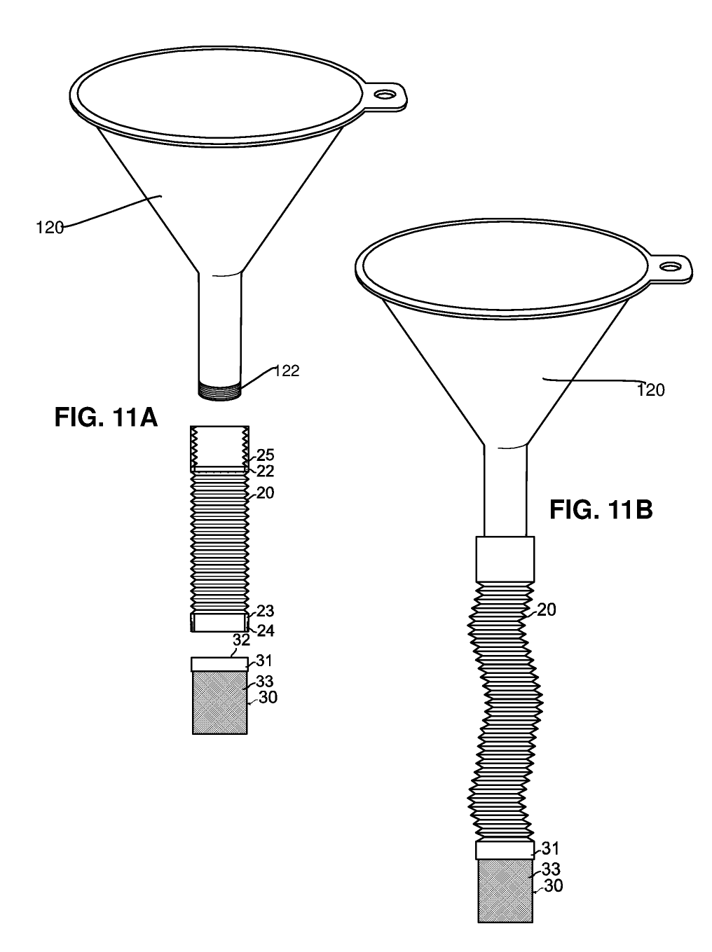

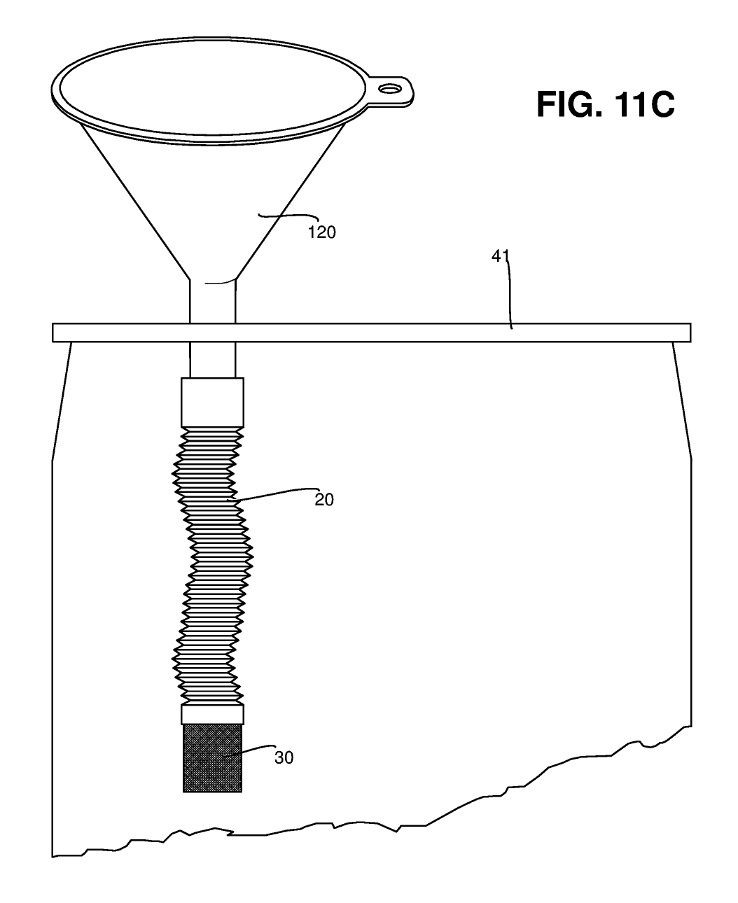

FIGS. 11a, 11b, 11c disclose a funnel 120 which can be coupled to an adjustable tube 20. With this design, funnel 120 can include a threaded region 122 which can be screwed onto tube 20 and into threaded region 25 of tube 20 as shown in FIGS. 11B and 11C.

FIG. 11C shows in particular, a design wherein funnel 120 is inserted into to a container 40 and which is also coupled to adjustable tube 20. Adjustable tube 20 is coupled at the opposite end to filter 30. Thus, this design forms a filtering element for filtering particles out from the ambient air and which prevents any liquid poured into container 40 from being contaminated in air.

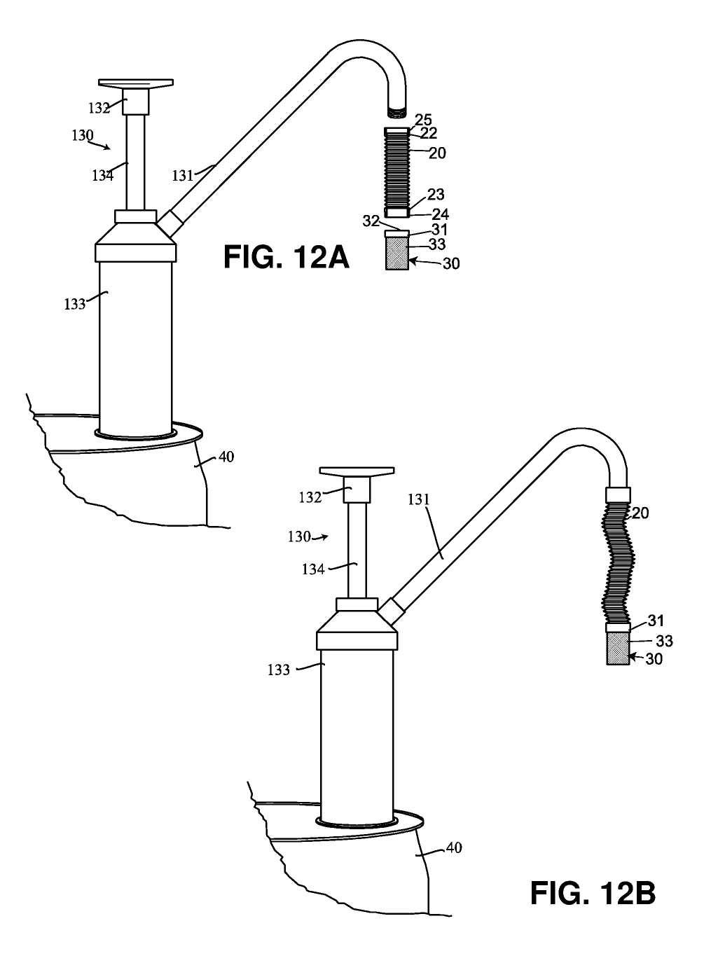

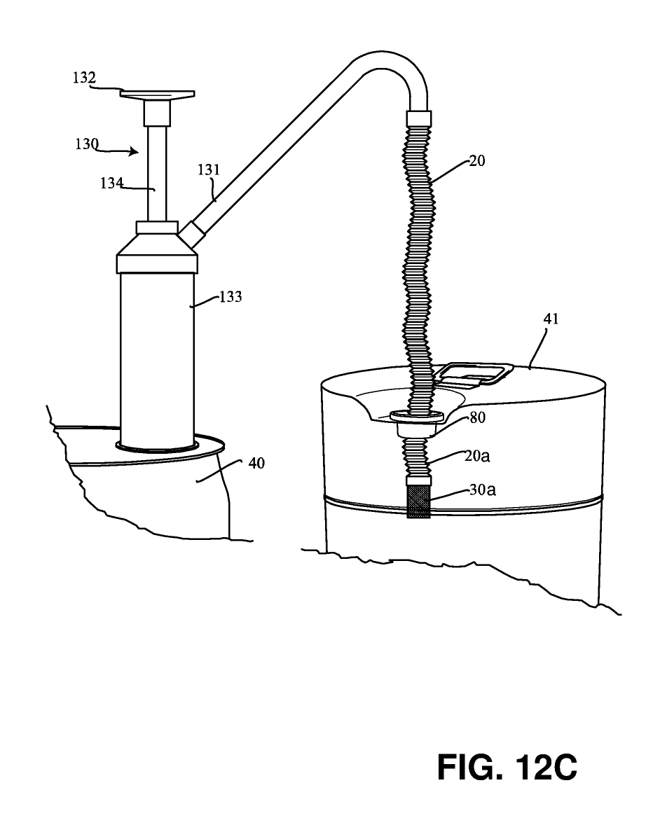

FIG. 12A is a side view of another embodiment of the invention. With this design, there is a pump 130 wherein this pump 130 includes a top 132, a shaft 134 a base 133 and a dispensing spout 131. When a user pushes down on top 132, it drives shaft 134 into base 133 to create a driving push on fluid to drive the fluid out from container 40 through spout 131, through tube 20 and down through filter 30.

FIG. 12B shows a side view of the design shown in FIG. 12A with the adjustable tube 20 being coupled to spout 131, and filter element 30 being coupled to adjustable tube 20.

FIG. 12C shows a side view of another design wherein with this design, pump 130 is coupled to a container 40 wherein when a user pushes down on top 132 it drives fluid out from container 40 through spout 131 into tube 20a, down through connector 80, through additional tube 20 and then through filter 30. In this way, the manual pumping of fluid from pump 130 coupled to container 40 allows fluid to flow in a closed environment from one container to another container while still being filtered as well.

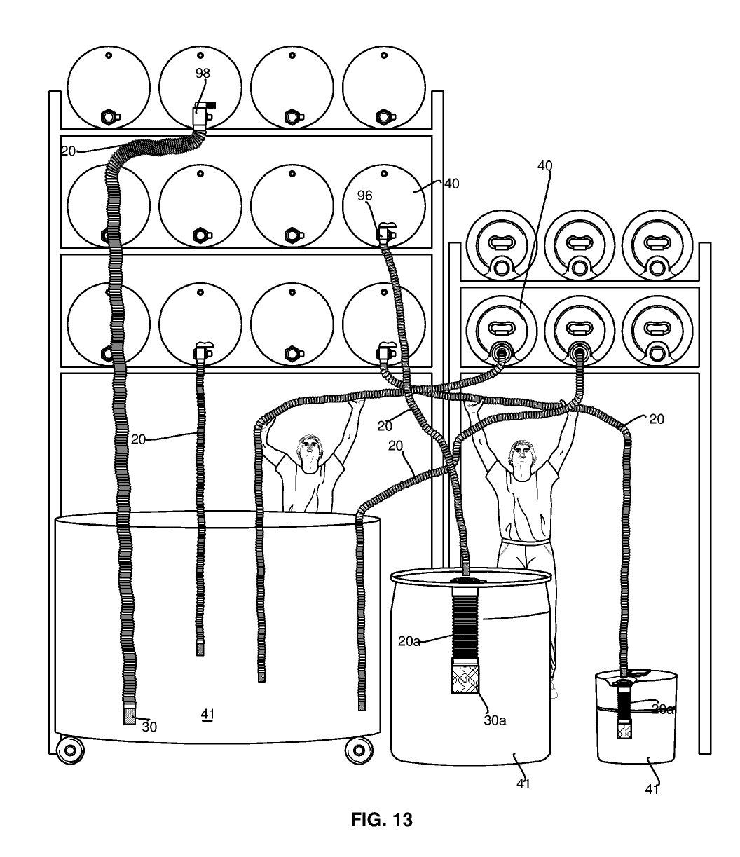

FIG. 13 shows a side view which discloses a plurality of containers disposed on a shelving system wherein these containers are coupled to elongated adjustable tubes 20 which function similar to adjustable tubes 20. Coupled to these containers are valves 61 or 80 which can be used to control the flow from a first container such as containers 40a, 40b, 40c, 40d, 40e, 40f, into secondary containers 41a, 41b and 41c. The process of transferring this fluid involves the transfer of fluid through a filter which is disposed inside of the second container. Thus, with this design, once one of these valves 61 or 80 is opened any contaminants inside of an initial container do not enter into these secondary containers because the contaminants are blocked by these filters connected to the dispensing container and any ambient contaminants are captured before the material enters the second container by the filters residing in these secondary containers 41a, 41b, and 41c.

This filtering effect is important because highly valuable materials, can become contaminated with relatively large or small sized particles in the dispensing container or when ambient dust enters the second container during a material transfer. Thus, while the adjustable tubes 20 allow for a direct adjustable connection between a first container and a second container, the filters 30 provide the necessary for effective cleaning of the solution.

In addition, it is important that these tubes are adjustable in length because by adjusting these tubes in length, the tube does not fold over itself or crimp, thus trapping valuable materials inside of the tube. Therefore, the length adjustability of these tubes provides a more direct flow of fluid from one container to another while avoiding unnecessary crimping in a connecting tube. The compression of the tube allows valuable material to be put back in the dispensing container or in the receiving container.

With these embodiments it is possible for a user to filter liquids, solutions, flavorings or gasses while transporting these materials from one container to another via the following process: opening a valve to allow a fluid to flow from a first container into an adjustable tube; continuing the flow of fluid from the adjustable tube through a first filter, positioning an opening below said first filter to receive the fluid; allowing the fluid to flow through the opening through a second adjustable tube which extends inside of a second container and then through a second filter inside the second container. This fluid then flows into this second container for additional storage. Finally the second container can be capped so that no additional impurities enter into this container.

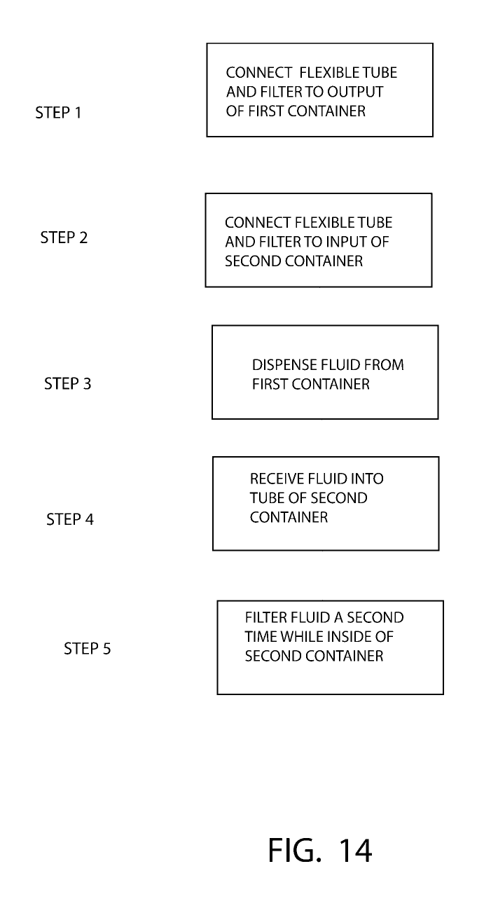

For example, FIG. 14 is a flow chart which shows the process for the filtering of fluids from one container to another. In this case, in step 1, a flexible tube 20 having a filter 30 disposed on the end of it can be coupled to a first container 40. In addition, either before or after this step, in step 2, a flexible tube 20 or 20a having a filter 30 or 30a disposed on the end of it can be coupled to a second container 41. Next, in step 3, fluid can be dispensed from the first container 40 through tube 20 and through filter 30.

Next, fluid can be received into the second flexible tube 20 or 20a inside of second container 41. This fluid is then filtered a second time inside second container 41 because filter 30 is disposed inside of second container 41. In this way, with flexible tube 20 or 20a being sealed against an opening in second container 41, no other impurities can enter into this second container 41 once the fluid has been transferred.

One additional steps may include collapsing one or more of tubes 20 or 20a to adjust their length, or to squeeze out any additional fluid. Another additional step may include capping the first dispensing container once the fluid has been transferred using a closure cap 110 or capping the receiving container 41 using closure cap 110 as well. This can occur once the flexible tubes are removed from the dispensing container 40 or the receiving container 41.

Accordingly, while only a few embodiments of the present invention have been shown and described, it is obvious that many changes and modifications may be made thereunto without departing from the spirit and scope of the invention.

What is claimed is:

1. A filter system for a container comprising:
a) a connector;
b) an adjustable tube coupled to said connector; and
c) a filter coupled to said adjustable tube.

2. The filter system as in claim 1, wherein said connector is in the form of a threaded connector for connecting to an opening of the container.

3. The filter system as in claim 2, wherein said connector is in the form of a octagon ring connector for connecting to an opening on a container.

4. The filter system as in claim 3, wherein said connector further comprises a ring.

5. The filter system as in claim 1, wherein said adjustable tube is adjustable in length including compressible in length of adjustable in length.

6. The filter system as in claim 5, wherein said adjustable tube is in the form of an accordion shaped tube.

7. The filter system as in claim 5, wherein said adjustable tube is in the form of a telescoping tube that is adjustable in length.

8. The filter system as in claim 1, wherein said filter is in the form of a bag.

9. The filter system as in claim 1, wherein said filter is selectively connectable to said adjustable tube.

10. The filter system as in claim 1, wherein said filter is in the form of a bag and further comprises a filter adapter having threads wherein said filter adapter can be screwed on to an end of said adjustable tube.

11. The filter system as in claim 1, wherein said filter is in the form of a mesh screen.

12. The filter system as in claim 1, wherein said filter is in the form of a flexible bag made from mesh.

13. The filter system as in claim 1, wherein said filter further comprises an adapter for coupling to said adjustable tube.

14. The filter system as in claim 13, wherein said adapter is a snap on adapter to couple said filter to said adjustable tube.

15. The filter system as in claim 1, wherein said connector is coupled to an output of a container.

16. A filter system comprising
a) a connector comprising a octagon-head;
b) an adjustable tube coupled to said connector wherein said adjustable tube is in the form of an accordion shaped tube, wherein said tube has a first end having a plurality of threads for coupling to said connector and a second end having a plurality of threads;
c) a filter in the form of a mesh bag coupled to said adjustable tube, wherein said filter is screwed onto said second end of said adjustable tube; and
d) a cover selectively insertable into said connector, wherein said connector has a receiving spout and said cover is selectively insertable into said receiving spout of said connector.

17. A process for filtering fluids from a first container to a second container comprising the steps of:
connecting a flexible tube having a filter to an output end of a first container;
connecting a flexible tube having a filter coupled to the end of it to an input of a second container;
dispensing a fluid from said first container through said flexible tube and said filter;
receiving said fluid from said first container in said second container; and
filtering said fluid a second time through said filter in said second container.

18. The process as in claim 17, further comprising the step of compressing said flexible tube coupled to said first container to remove excess fluid disposed in said flexible tube.
